(19) United States
(12) Patent Application Publication
(10) Pub. No.: US 2011/0238486 A1
(43) Pub. Date: Sep. 29, 2011

(54) Optimizing Sponsored Search Ad Placement for Online Advertising

(76) Inventors: Weiguo Liu, Santa Clara, CA (US); Jinlin Wang, Mountain View, CA (US)

(21) Appl. No.: 12/749,372

(22) Filed: Mar. 29, 2010

(51) Int. Cl. G06Q 30/00; G06Q 10/00

(52) U.S. Cl. 705/14.42; 705/14.43

(57) ABSTRACT

A method and a system are provided for optimizing sponsored search ad placement for online advertising. In one example, the system obtains advertiser bid amount information. The system obtains advertiser bid amount information. The bid amount information allows determination of amounts that advertisers will pay per user click on ads served in association with advertiser bids. The advertiser bid amounts are associated with advertising campaigns. The system obtains click-through-rate information associated with at least some of the ads. The system obtains budget information associated with the advertising campaign. The budget information specifies a maximum advertiser spending over a period of time in association with at least a portion of the advertising campaign. The system ranks a set of ads to be served based on the bid amount information, the click-through-rate information, and/or the budget information. The system optimizes ad placement of the set of ads by eliminating one or more keywords. The system then facilitates serving of the set of ads in accordance with at least one of the ranking of the set of ads and the optimizing of the ad placement.

### FIELD OF THE INVENTION

The invention relates to online advertising. More particularly, the invention relates to optimizing sponsored search ad placement for online advertising.

### BACKGROUND

An advertiser, such as Ford™ or McDonald's™, generally contracts a creative agency for ads to be placed in various media for the advertiser's products. Such media may include TV, radio, Internet ads (e.g., sponsored search ads, banner display ads, textual ads, streaming ads, mobile phone ads, etc.) or print median ads (e.g., ads in newspapers, magazines, posters, etc.). It is quite possible that the advertiser may engage one or more creative agencies that specialize in creating ads for one or more of the above media. A company wants to show the most relevant ads to end users in order to get the most value from their ad campaign.

Sponsored search is enormously profitable business for marketplace providers, such as search engines like Yahoo!™. In early forms, sponsored search marketplaces, such as those provided by search engines, included ranking and pricing of ads based solely on advertisers' bid amounts associated with the keywords in a sponsored search auction.

However, marketplace provider (or search engine) revenue was influenced not only by bid amounts, but also by click-through-rates associated with the served ads. Recognizing this, ranking and pricing methods arose in which not only bid amount, but also click-through-rates associated with ads, became utilized as factors influencing ad ranking and pricing in sponsored search. By bringing the focus more on, and substantially increasing, search engine revenue, this new approach to ranking and pricing led to a huge increase in search engine profit from the already hugely profitable business of sponsored search. In addition, it may be viewed that, by increasing user clicks on ads, this change of focus and methodology also led to a more efficient, and healthier sponsored search marketplace overall, for the search engine, the advertisers, and the users (e.g., consumers).

In sponsored search, as in any other marketplaces, a company like Yahoo!™ must face limited resources and ever demanding market requirements. The inventory includes all advertising slots on search result pages. While the total supplies of slots may be large, the relevant and heavily searched and clicked slots are precious. Search engines face the challenge of placing the right ads in the right slots and maximize the utilization of the inventory. Accordingly, one fundamental problem of sponsored search is where to place the ads, so that the inventories are well utilized, the pages are relevant to search users, and the valuable traffics are sent to advertisers.

### SUMMARY

What is needed is an improved method having features for addressing the problems mentioned above and new features not yet discussed. Broadly speaking, the invention fills these needs by providing a method and a system for optimizing sponsored search ad placement for online advertising.

In a first embodiment, a computer-implemented method is provided for optimizing sponsored search item (e.g., ad) placement. The method comprises at least the following: obtaining, at a computer, messenger (e.g., advertiser) bid amount information; obtaining, at a computer, messenger bid amount information, wherein the messenger bid amount information allows determination of amounts that messengers will pay per user click on items served in association with messenger bids, wherein the messenger bid amounts are associated with messaging (e.g., advertising) campaigns; obtaining, at a computer, click-through-rate information associated with at least some of the items; obtaining, at a computer, budget information associated with the messaging campaign, wherein the budget information specifies a maximum messenger spending over a period of time in association with at least a portion of the messaging campaign; ranking, at a computer, a set of items to be served based on at least one of the bid amount information, the click-through-rate information, and the budget information; optimizing, at a computer, item placement of the set of items by eliminating one or more keywords; and facilitating, at a computer, serving of the set of items in accordance with at least one of the ranking of the set of items and the optimizing of the item placement.

In a second embodiment, a system is provided for optimizing sponsored search item placement. The system comprises at least a computer system configured for at least the following: obtaining, at a computer, messenger bid amount information; obtaining, at a computer, messenger bid amount information, wherein the messenger bid amount information allows determination of amounts that messengers will pay per user click on items served in association with messenger bids, wherein the messenger bid amounts are associated with messaging campaigns; obtaining, at a computer, click-through-rate information associated with at least some of the items; obtaining, at a computer, budget information associated with the messaging campaign, wherein the budget information specifies a maximum messenger spending over a period of time in association with at least a portion of the messaging campaign; ranking, at a computer, a set of items to be served based on at least one of the bid amount information, the click-through-rate information, and the budget information; optimizing, at a computer, item placement of the set of items by eliminating one or more keywords; and facilitating, at a computer, serving of the set of items in accordance with at least one of the ranking of the set of items and the optimizing of the item placement.

In a third embodiment, a computer readable medium is provided comprising one or more instructions for optimizing item placement. The one or more instructions are configured for causing one or more processors to perform at least the following steps: obtaining, at a computer, messenger bid amount information; obtaining, at a computer, messenger bid amount information, wherein the messenger bid amount information allows determination of amounts that messengers will pay per user click on items served in association with messenger bids, wherein the messenger bid amounts are associated with messaging campaigns; obtaining, at a computer, click-through-rate information associated with at least some of the items; obtaining, at a computer, budget information associated with the messaging campaign, wherein the budget information specifies a maximum messenger spending over a period of time in association with at least a portion of the messaging campaign; ranking, at a computer, a set of items to be served based on at least one of the bid amount information, the click-through-rate information, and the budget information; optimizing, at a computer, item placement of the set of items by eliminating one or more keywords; and facilitating, at a computer, serving of the set of items in accordance with at least one of the ranking of the set of items and the optimizing of the item placement.

The invention encompasses other embodiments configured as set forth above and with other features and alternatives. It should be appreciated that the invention may be implemented in numerous ways, including as a method, a process, an apparatus, a system or a device.

### BRIEF DESCRIPTION OF THE DRAWINGS

The invention will be readily understood by the following detailed description in conjunction with the accompanying drawings. To facilitate this description, like reference numerals designate like structural elements.

FIG. 1 is a high-level block diagram of a system for optimizing sponsored search ad placement for online advertising, in accordance with some embodiments;

FIG. 2 is a flowchart of a method for optimizing revenue for a search engine by ranking ads, in accordance with some embodiments;

FIG. 3 is a flowchart of another method for optimizing revenue for a search engine by ranking ads, in accordance with some embodiments;

FIG. 4 is a conceptual block diagram of a system for sponsored search, which may include software, in accordance with some embodiments;

FIG. 5 is a conceptual block diagram of a system for optimizing sponsored search for online ads, in accordance with some embodiments;

FIG. 6 is a flowchart of a method for optimizing sponsored search ad placement (e.g., item placement) for online advertising (e.g., online messaging), in accordance with some embodiments; and

FIG. 7 is a diagrammatic representation of a network, including nodes that may comprise a machine within which a set of instructions may be executed, in accordance with some embodiments.

### DETAILED DESCRIPTION

An invention is disclosed for a method and a system for optimizing sponsored search ad placement for online advertising. Numerous specific details are set forth in order to provide a thorough understanding of the invention. It will be understood, however, to one skilled in the art, that the invention may be practiced with other specific details.

### DEFINITIONS

Some terms are defined below in alphabetical order for easy reference. These terms are not rigidly restricted to these definitions. A term may be further defined by its use in other sections of this description.

“Ad” (e.g., ad, item and/or message) means a paid announcement, as of goods or services for sale, preferably on a network, such as the Internet. An ad may also be referred to as an ad, an item and/or a message.

“Ad Server” is a server that is configured for serving one or more ads to user devices. An ad server is preferably controlled by a publisher of a web site and/or an advertiser of online ads. A server is defined below.

“Advertiser” (e.g., messenger and/or messaging customer, etc.) means an entity that is in the business of marketing a product and/or a service to users. An advertiser may include without limitation a seller and/or a third-party agent for the seller. An advertiser may also be referred to as a messenger and/or a messaging customer. Advertising may also be referred to as messaging.

“Advertising” means marketing a product and/or service to one or more potential consumers by using an ad. One example of advertising is publishing a sponsored search ad on a website.

“Application server” is a server that is configured for running one or more devices loaded on the application server. For example, an application server may run a device configured for targeting online ads.

“Bid” means keywords for which an advertiser would like to send an ad in a sponsored search. An advertiser may show desire/demand for keywords by adjusting budget constraints within an ad campaign.

“Client” means the client part of a client-server architecture. A client is typically a user device and/or an application that runs on a user device. A client typically relies on a server to perform some operations. For example, an email client is an application that enables a user to send and receive e-mail via an email server. The computer running such an email client may also be referred to as a client.

“Database” (e.g., database system, etc.) means a collection of data organized in such a way that a computer program may quickly select desired pieces of the data. A database is an electronic filing system. In some instances, the term “database” is used as shorthand for “database management system”.

“Device” means hardware, software or a combination thereof. A device may sometimes be referred to as an apparatus. Examples of a device include without limitation a software application such as Microsoft Word™, a laptop computer, a database, a server, a display, a computer mouse and/or a hard disk.

“Item” means an ad, which is defined above.

“Marketplace” means a world of commercial activity where products and/or services are browsed, bought and/or sold, etc. A marketplace may be located over a network, such as the Internet. A marketplace may also be located in a physical environment, such as a shopping mall.

“Message” means an ad, which is defined above.

“Messaging” means advertising, which is defined above.

“Messenger” means an advertiser, which is defined above.

“Network” means a connection, between any two or more computers, that permits the transmission of data. A network may be any combination of networks, including without limitation the Internet, a local area network, a wide area network, a wireless network and a cellular network.

“Publisher” means an entity that publishes, on a network, a web page having content and/or ads, etc.

“Ranking” means the order in which items such as ads are positioned or presented with respect to one another. For example, ranking issues would include issues such as whether ad A is in position 1 and ad B is in position 2, or the reverse, where ad A is in position 2 and ad B is in position 1, etc. In particular for this invention the ranking may not be a fixed position, but rather a service distribution to multiple positions. The relative rankings are also not fixed to achieve the true maximization of search engine revenue.

“Server” means a software application that provides services to other computer programs (and their users), in the same computer or other computer. A server may also refer to the physical computer that has been set aside to run a specific server application. For example, when the software Apache HTTP Server is used as the web server for a company's web site, the computer running Apache may also be called the web server. Server applications may be divided among server computers over an extreme range, depending upon the workload.

“Software” means a computer program that is written in a programming language that may be used by one of ordinary skill in the art. The programming language chosen should be compatible with the computer by which the software application is to be executed and, in particular, with the operating system of that computer. Examples of suitable programming languages include without limitation Object Pascal, C, C++ and Java. Further, the functions of some embodiments, when described as a series of steps for a method, could be implemented as a series of software instructions for being operated by a processor, such that the embodiments could be implemented as software, hardware, or a combination thereof. Computer readable media are discussed in more detail in a separate section below.

“System” means a device or multiple coupled devices. A device is defined above.

“User” (e.g., consumer, etc.) means an operator of a user device. A user is typically a person who seeks to acquire a product and/or service. For example, a user may be a woman who is browsing Yahoo!™ Shopping for a new cell phone to replace her current cell phone. The term “user” may refer to a user device, depending on the context.

“User device” (e.g., computer, user computer, client and/or server, etc.) means a single computer or to a network of interacting computers. A user device is a computer that a user may use to communicate with other devices over a network, such as the Internet. A user device is a combination of a hardware system, a software operating system and perhaps one or more software application programs. Examples of a user device include without limitation a laptop computer, a palmtop computer, a smart phone, a cell phone, a mobile phone, an IBM-type personal computer (PC) having an operating system such as Microsoft Windows™, an Apple™ computer having an operating system such as MAC-OS, hardware having a JAVA-OS operating system, and a Sun Microsystems Workstation having a UNIX operating system.

“Web browser” means a software program which can display text, graphics, or both, from web pages on web sites. Examples of a web browser include without limitation Mozilla Firefox™ and Microsoft Internet Explorer™.

“Web page” means documents written in a mark-up language including without limitation HTML (hypertext mark-up language), VRML (virtual reality modeling language), dynamic HTML, XML (extended mark-up language) and/or other related computer languages. A web page may also refer to a collection of such documents reachable through one specific Internet address and/or through one specific web site. A web page may also refer to any document obtainable through a particular URL (Uniform Resource Locator).

“Web server” is a server configured for serving at least one web page to a web browser. An example of a web server is a Yahoo!™ web server. A server is defined above.

“Web site” means one or more web pages. A web site preferably includes plurality of web pages, virtually connected to form a coherent group.

### General Overview

A system is provided for solving the ad placement problem for a set of ad campaigns. The formulation takes into consideration inventory limitations, ad campaign budget constraints, search relevance, and click conversion rates, among other things. The formulation may be applied to solve a wide range of problems, including without limitation budget limited inventory optimization, advertiser keywords and bid recommendations.

The system is configured to capture the essentials of the problems and to be flexible enough to fit into various applications. A problem is to determine positions for multiple ad campaigns and hundreds or thousands keywords from these ad campaigns. The objective of the system may be to maximize the overall revenue and keep a high relevance level for each search page. Alternatively, in case of the ad campaign recommendations, the objective may be to maximize the total clicks under a specified budget amount for each ad campaign.

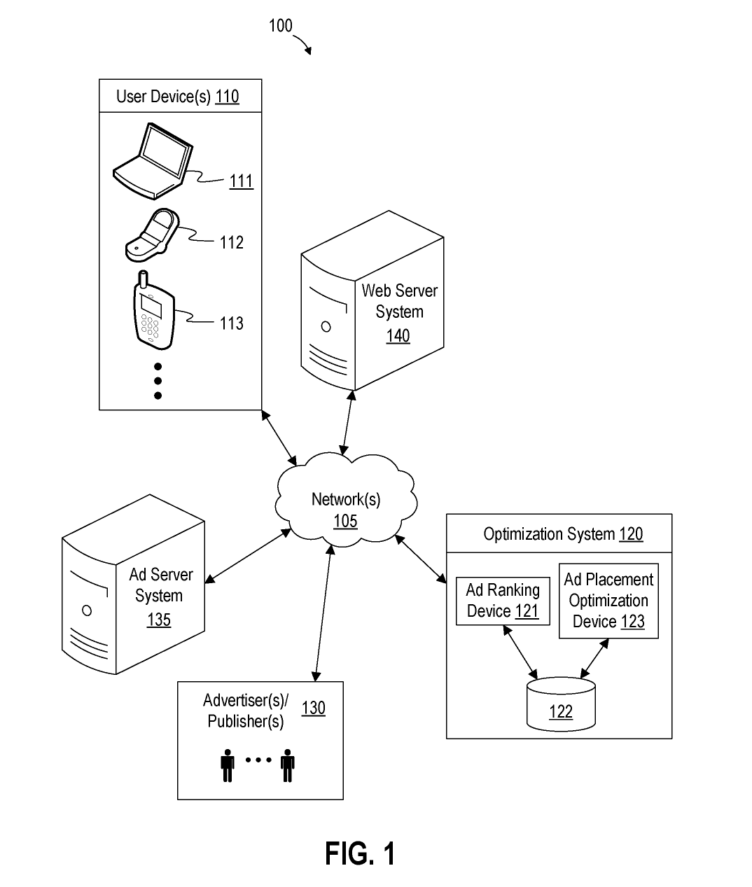

FIG. 1 is a high-level block diagram of a system 100 for optimizing sponsored search ad placement for online advertising, in accordance with some embodiments. The one or more networks 105 couple together one or more user devices 110, an optimization system 120, one or more advertiser(s)/publisher(s) 130, an ad server system 135 and a web server system 140. The network 105 may be any combination of networks, including without limitation the Internet, a local area network, a wide area network, a wireless network and/or a cellular network.

Each user device 110 includes without limitation a single computer or a network of interacting computers. Examples of a user device include without limitation a laptop computer 111, a cell phone 112 and a smart phone 113. A user may communicate with other devices over the network 105 by using a user device 110. A user may be, for example, a person browsing or shopping in a marketplace on the Internet.

The web server system 140 may include without limitation web servers, application servers, search engines and/or databases. The web server system 140 is configured for communicating with the user devices 110 and serving at least one web page to a web browser on a user device 110. The web server system 140 is configured for providing online services, including without limitation searching, browsing and/or shopping operations.

The optimization system 120 includes without limitation an ad ranking device 121, an ad placement optimization device 123 and a database system. The ad ranking device 212 is configured for ranking suitable of ads for given advertising slots on search result pages. The ad placement optimization device 123 is configured for optimizing sponsored search ad placement. The database system 122 is configured for storing data generated by the ad ranking device 121 and/or the ad placement optimization device 123.

The optimization system 120 is configured for programs, algorithms, applications, software, graphical user interfaces, models, other tools and/or other procedures necessary to implement and/or facilitate methods and systems according to embodiments of the invention, or computerized aspects thereof, whether on one computer or distributed among multiple computers or devices. These include local and global adjustment, decision making, or optimizations, ranking, pricing, allocation, scheduling, serving, and/or other techniques. In various embodiments, the elements of the optimization system 120 may exist on one computer, or may exist on multiple computers, devices and/or locations.

The ad server system 135 may include without limitation ad servers, application servers and/or databases. The ad server system 135 is configured for serving one or more ads to the user devices 110. An ad server system 135 is preferably controlled by a publisher 130 of a web site and/or an advertiser 130 of online ads. A publisher 130 is an entity that publishes, over the network 105, a web page having content and/or ads. An advertiser 130 is an entity that is seeking to market a product and/or a service to users at the user devices 110. Examples of a publisher/advertiser 130 include without limitation Yahoo!™, Amazon.com™ and Nike™.

The configuration of the system 100 in FIG. 1 is for explanatory purposes. For example, in some embodiments, the ad server system 135 may be part of an ad exchange. For example, some Web portals operate, utilize, or facilitate advertising exchanges. Such exchanges may virtually connect parties including advertisers, publishers, networks of advertisers, networks of publishers, and other entities. The exchange may facilitate arrangements, bidding, auctioning in connection with ads and ad campaigns, and may also facilitate planning and serving of ads. Ads that may be included within the exchange may include display or graphical ads that are not served in connection with user searches including keyword-based searches. The exchange may also include sponsored search ads, including ads served in association with user searches, such as keyword searches. Any type of simple or sophisticated ads may be included, such as text, graphic, picture, video and audio ads, streaming ads, interactive ads, rich median ads, etc.

In some embodiments, active ads are ads that are available for serving on or in connection with the exchange, whereas non-active ads are not so available. For example, non-active ads may include ads that are in review prior to be available for serving. This may include review as part of an editorial process to try to ensure or reduce the chance that inappropriate or dangerous ads are not allowed to be active. There are numerous other configurations in other embodiments that are possible.

### Optimizing Revenue for a Search Engine by Ranking Ads

The present invention is directed toward optimizing sponsored search ad placement by eliminating bids (e.g., keywords) to satisfy budget constraints of advertisers. Accordingly, satisfying a budget constraint may be accomplished by eliminating bids (e.g., keywords) from an advertising campaign. This process of optimizing sponsored search ad placement by eliminating keywords is discussed below in a separate section.

Before describing optimization of search ad placement, it is important to explain, in detail, the process of optimizing total revenue for a search engine. Optimizing the total revenue for a search engine (e.g., Yahoo!™) may be accomplished by altering the ordering of the second price auction, described below, for some budget tight advertising campaigns. This process of optimizing total revenue is discussed in detail in this section here.

Revenue of a search engine may be optimized by ranking sponsored search ads. Some embodiments of the invention provide methods and systems for ranking sponsored search ads, and for auction pricing, based on factors including an advertiser-associated budget over a period of time. In some embodiments, methods and systems are provided for ranking of sponsored search ads based on factors including budgets associated with ad campaigns or portions thereof. Methods are provided in which linear programming or other techniques are used in ranking sponsored search ads based on factors including an advertiser bid amount associated with the ad, a historical, estimated or predicted click-through-rate associated with the ad, an estimated inventory amount or number of clicks obtained at each position of search result pages for the next serving period, and a budget over a period of time, such as a daily budget, the budget including spend associated with the ad.

Herein, the term “ranking” includes the order in which items such as ads are positioned or presented with respect to one another. For example, ranking issues would include issues such as whether ad A is in position 1 and ad B is in position 2, or the reverse, where ad A is in position 2 and ad B is in position 1, etc. In particular for this invention the ranking may not be a fixed position, but rather a service distribution to multiple positions. The relative rankings are also not fixed to achieve the true maximization of search engine revenue.

An advertiser associated budget can include, for example, an advertiser specified maximum amount of spending over a specified period of time, or over a specified repeating period of time, such as a daily budget. Such a specified maximum amount of spending may be, for example, specified in a contract or agreement. In some instances, advertisers may use different budgets to explore or experiment with the effects of different maximum spending amounts, or for other reasons. The advertisers' specification may appear at various keyword group levels for example at account level and/or at a lower campaign level.

In some embodiments, marketplace provider or search engine revenue from sponsored search is greatly increased relative to previous ranking and pricing methods. For instance, previous ranking and pricing methods have used bid amounts and estimated or predicted click-through-rates. In some embodiments of the invention, advertiser budgets, associated with ad campaigns or portions thereof, are taken into account in ranking and pricing. This can greatly increase search engine revenue as well as enhance marketplace efficiency generally.

For example, ad rank in a search result page may substantially influence the click-through-rate associated with ads. Furthermore, search engines advertising inventory, or most effective advertising inventory, as well as opportunities relating to such inventory, are limited. Still further, if ranking is determined without taking budget information into account, then budgets may be exhausted prior to the expiration of the time period associated with the budgets. This can lead to situations in which, although it may be more optimal to serve certain ads, they may not be able to be served, because an associated budget has been exhausted. This, in turn, can lead to empty spots for ads, or less optimal ads needing to be served. However, if ads are ranked with budgets in mind, a more optimal situation can result.

For instance, tighter budgets may lead to lower ranked ads. Because of the tighter budget, a lower position may be enough to reach the budget limit. However, lowering the rank of the tighter budget ads can open up higher rank spots for ads with sufficient budget. Estimates or predictions relating to click-through-rates, serving opportunities, targeting opportunities, etc., along with bid amount information and budget information can allow much more optimized planning, scheduling, allocation and ranking of ads. Overall, this allows better use of all budgets, and leads to more revenue for the search engine. Of course, this is just a simplified explanation, but it demonstrates the point. Since sponsored search is an enormous source of revenue for search engines, and since this type of situation occurs very frequently, the associated increase in search engine revenue can be huge.

It should be noted that, in embodiments of the invention, information and factors influencing ranking and pricing are considered dynamically and globally, over many or all advertiser accounts, campaigns, budgets, serving opportunities, advertising inventory, etc. In some embodiments, global optimization of ranking and pricing including bid amount, click through, and budget information leads to optimized search engine provider revenue. Furthermore, as described herein, optimization, including ranking, can be considered over many serving events and over a period of time, and can include, for example, assigning optimal percentages of presentation of particular ads at particular ranks based on factors including budgets, etc. As such, embodiments of the invention include optimization relating to ranking distributions over time and many events, etc. Linear programming or other techniques can be used in such optimization.

Furthermore, in various embodiments of the invention, optimization can be performed globally considering bid amount information, click-through-rate information, and budget information. Alternatively, such optimization can be performed in steps. For example an optimization step can be performed first without taking into account budget information, and then resulting parameters, such as rank and pricing, can be adjusted by factoring in budget and/or other revenue related information.

In some embodiments, auction pricing may be influenced by budgets, for example, in addition to ranking. For instance, advertisers may specify bid ranges, and methods according to embodiments of the invention may choose optimal specific bids. This can lead not only to optimized search engine revenue, but also to advantages to advertisers. It can also lead to a mechanism for leading to advertiser's choosing optimal budgets and bid amounts or ranges for the marketplace as a whole.

In some embodiments, pricing may be adjusted or otherwise determined based in part on factors including advertiser budgets. For example, in some embodiments, pricing for an advertiser with insufficient budget may be adjusted slightly upward to discourage or penalize lower budgets.

For instance, a tighter budget advertiser might bid lower, or have his bid amount adjusted to a lower end of the range, leading to lower rank and lower click-through-rate, since a greater number of serving opportunities relative to the budget may nonetheless lead to exhaustion of the budget and the same number of clicks as if the advertiser had bid higher. Conversely, a higher budget advertiser may more optimally bid higher, obtaining higher rank and click-through-rate, since serving opportunities may otherwise be insufficient to exhaust the advertiser's budget. A similar type of analysis applies to budget increases or decreases, in that a higher budget may encourage higher bids, etc. As a result, ranking and/or pricing based on information including budgets leads to more rational and efficient advertiser decision-making as well as more optimal allocation of advertiser resources. This in turn, leads to more search engine revenue and a more efficient marketplace.

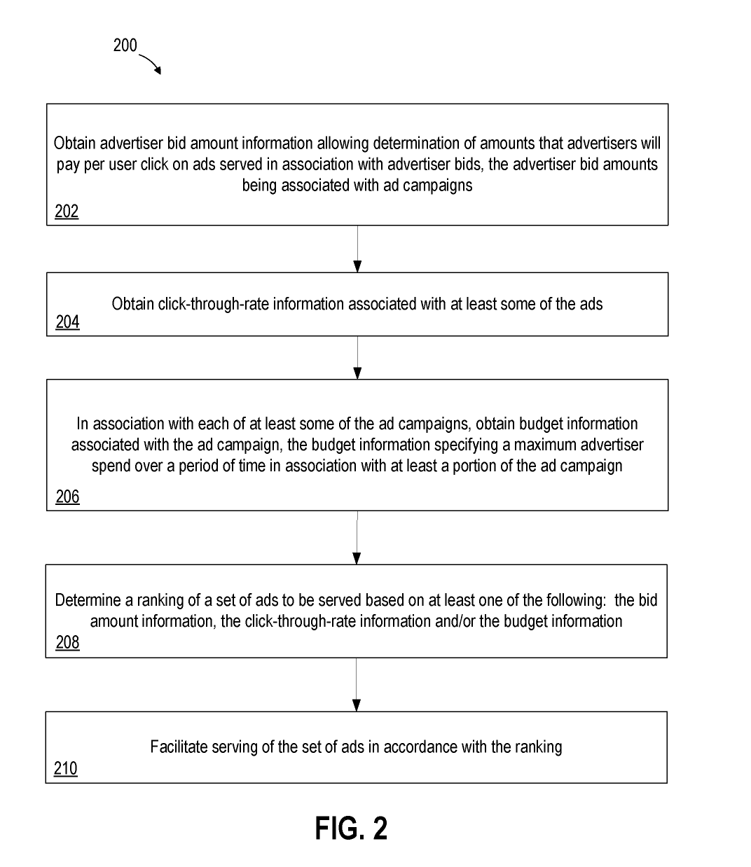

FIG. 2 is a flowchart of a method 200 for optimizing revenue for a search engine by ranking ads, in accordance with some embodiments. The method 200 may be facilitated or implemented using the ad ranking device 121 of FIG. 1.

At a step 202, using one or more computers, in a sponsored search auction, the system obtains advertiser bid amount information. The advertiser bid amount information allows determination of amounts that advertisers will pay per user click on ads served in association with advertiser bids. The advertiser bid amounts are associated with ad campaigns.

At a step 204, using one or more computers, the system obtains click-through-rate information. The click-through-rate information is associated with at least some of the ads.

At a step 206, using one or more computers, in association with each of at least some of the ad campaigns, the system obtains budget information associated with the ad campaign. The budget information specifies a maximum advertiser spending over a period of time in association with at least a portion of the ad campaign.

At a step 208, the system determines a ranking of a set of ads to be served based on at least one of the following: the bid amount information, the click-through-rate information and/or the budget information.

At a step 210, the system facilitates serving of the set of ads in accordance with the ranking.

Note that the method 200 may include other details and steps that are not discussed in this method overview. Other details and steps are discussed with reference to the appropriate figures and may be a part of the method 200, depending on the embodiment.

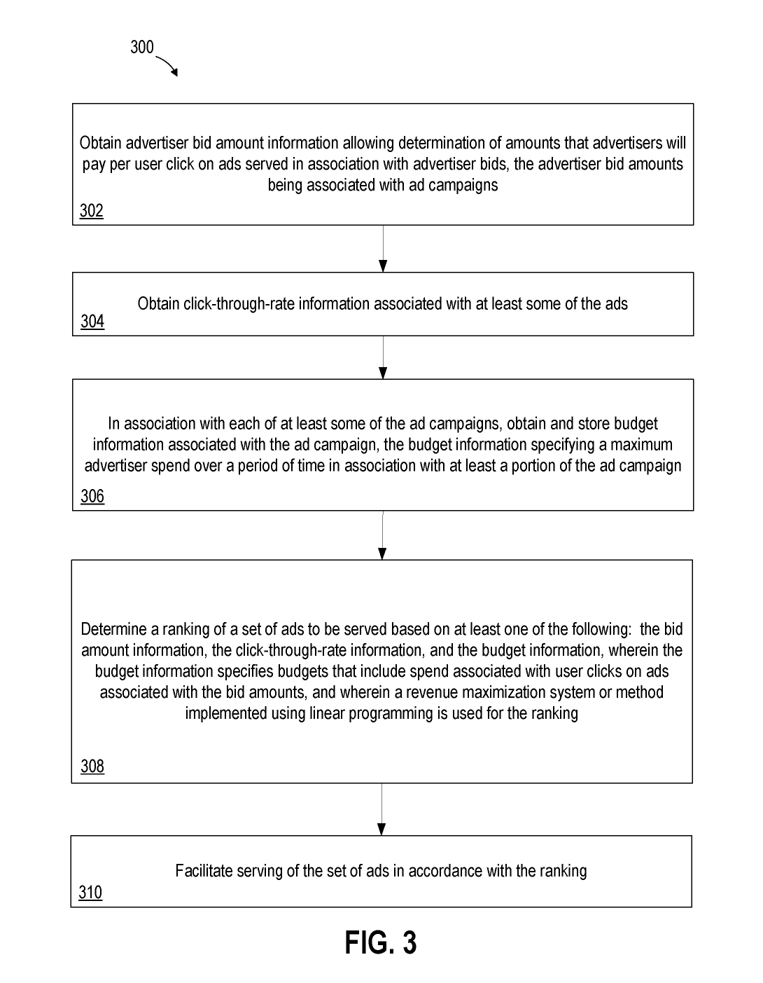

FIG. 3 is a flowchart of another method 300 for optimizing revenue for a search engine by ranking ads, in accordance with some embodiments. The method 300 may be facilitated or implemented using the ad ranking device 121 of FIG. 1.

Steps 302, 304 and 306 of the method 300 of FIG. 3 are similar to steps 202, 204 and 206, respectively, of the method 200 of FIG. 2.

At a step 308, the system determines a ranking of a set of ads to be served based on at least one of the following: the bid amount information, the click-through-rate information and/or the budget information. The budget information specifies budgets that include spending associated with user clicks on ads associated with the bid amounts. A revenue maximization system or method implemented as a linear programming is preferably used for the ranking process.

Step a 310 of the method 300 of FIG. 3 is similar to the step 210 of the method 200 of FIG. 2.

Note that the method 300 may include other details and steps that are not discussed in this method overview. Other details and steps are discussed with reference to the appropriate figures and may be a part of the method 300, depending on the embodiment.

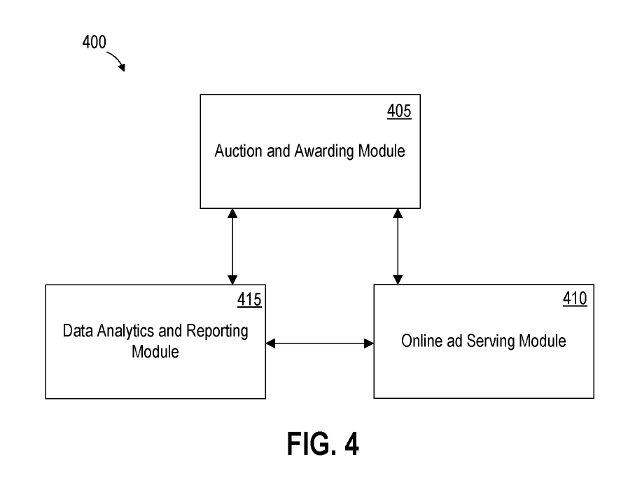

FIG. 4 is a conceptual block diagram of a system 400 for sponsored search, which may include software, in accordance with some embodiments. The system 400 includes an auction and awarding module 405, an online ad serving module 410, and a data analytics and reporting module 415. Although conceptually depicted separately, it is to be understood that the functions of the modules 405, 410, 415 may not be entirely separate, may overlap, etc., and all of the modules 405, 410, 415 may be in communication with each other.

In some embodiments, the auction and awarding module 405 includes functionality in connection with operation and management of a sponsored search auction. The auction and awarding module 405 may include functionality including planning, including offline planning, decision-making or determination-making, advertiser communications in connection with the auction, obtaining bidding-related and offer data, allowing and facilitating bidding, determining pricing, etc. Generally, functionality of the auction and awarding module 405 includes functionality represented by the ad ranking device 121 as depicted in FIG. 1. In some embodiments, the online ad serving module 410 includes functionality in connection with serving of ads, which may include implementing planning performed by the auction and awarding module 405, actually serving ads, pages, etc. The online ad serving module 410 may also include obtaining, tracking, and communication of data in connection with the serving, associated activities, or user behavior associated with the serving, the served ads, etc. This may include communication of such data to the data analytics and reporting module 415.

In some embodiments, the data analytics and reporting module 415 includes functionality relating to analyzing, using, mining, and reporting based on data obtained or communicated by other modules, such as the auction and awarding module 405 and the online ad serving module 410. In some embodiments, the functionality may include forecasting, such as click-through-rate forecasting, and inventory estimation, such as estimating the number of clicks at each position for the next service period, etc. This data may be communicated to and used by, for example, the auction and awarding module 405. Furthermore, this may create a cyclic or repeating pattern, including repeated communications between the modules 405, 410, 415.

It is to be understood that, in some embodiments, the data analytics and reporting module 415, including its functionality and output, may be used for entirely different uses other than, or in addition to, those described above in connection with ad ranking, etc. For example, such functionality and data may be used for analysis, statistical analysis, user behavior and/or ad campaign performance analysis, data mining, etc. Such functionality and data also may be used for any number of different purposes for which such data may be useful, provide insight, be pertinent and/or be minable to obtain pertinent information.

An assignment type of linear programming formulation is used to find an optimal ad placement for the next serving period. A serving period may be one day or a few hours.

The formulation requires estimation of average number of clicks and cost per click for each position at each relevant search result page. It also utilizes a relative strength, sometimes called “clickability” (e.g., quality score), of each ad campaign. These estimations may be obtained from the historical ad serving and performance data. Since the formulation runs each serving period, the service results from the last serving period will certainly be used to update the parameter estimation for the new period. In applications that ad campaigns are target weeks or months long, the initial lack of accuracy of the estimation will be overcome by the further training during the serving of the ad campaigns. The iterative updates make the optimization more robust.

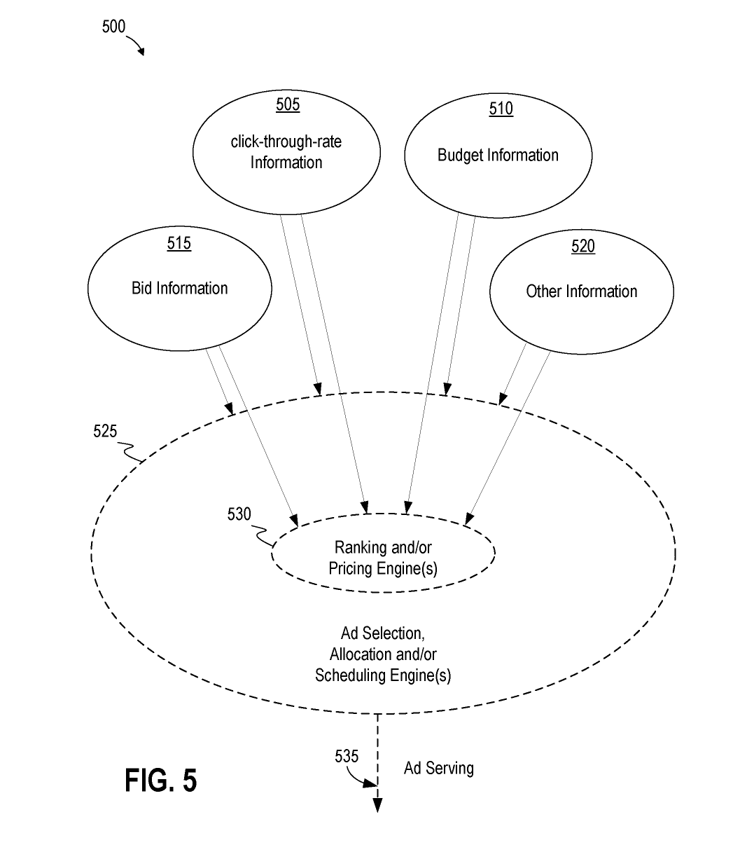

FIG. 5 is a conceptual block diagram of a system 500 for optimizing sponsored search for online ads, in accordance with some embodiments. One or more ranking and pricing engines 530 are within one or more ad selection/allocation/scheduling engines 525. Although depicted conceptually as within the ad selection/allocation/scheduling engine 525, it is to be understood that the ranking/pricing engine 530 may be separate, partially or completely within, or overlap with, the ad selection/allocation/scheduling engine 525, in terms of programming, functionality, and implementation. Further, it is to be understood that the ad selection/allocation/scheduling engine 525 is depicted merely conceptually. Its functions may overlap with other functions, may be distributed between or may include other functions, etc.

In some embodiments, the functionality of the ranking/pricing engine 530 and of the ad selection/allocation/scheduling engine 525 may correspond to or partially correspond to the functionality of the auction and awarding module 405 as depicted in FIG. 4. Furthermore, ad serving 535 may correspond or partially correspond in functionality to the online ad serving module 410 as depicted in FIG. 4. Still further, the various data 515 through 520 may correspond or partially correspond to data provided by the data analytics and reporting module 415 as depicted in FIG. 4.

As depicted in FIG. 5, information is obtained by the ranking/pricing engine 530 and the ad selection/allocation/scheduling engine 525, including without limitation click-through-rate information 505, budget information 510, bid information 515, and other information 520. The ranking and pricing engine 530 may use the click-through-rate information 505, the budget information 510, the bid information 515 and/or the other information 520, in determining auction pricing, such as, for example, reserve pricing, and in ranking of sponsored search ads. The c

The assignment relationship may be represented in a two level network. In a first level, the source nodes of the network are ad campaigns, including without limitation the click-through-rate information 505 and the budget information 510. The intermediate nodes are called bids which are ad campaign-keyword pairs, including without limitation the bid information 515 and the other information 520. One keyword used by different ad campaigns becomes different nodes in the network. In a second level, the sink nodes are the positions in the search engine result pages to which a bid may be assigned. This second level includes without limitation the one or more ranking/pricing engines 530 and the one or more ad selection/allocation/scheduling engines 525.

The following includes a description of a context of some embodiments of the invention as well as details and simplified examples relating to some embodiments of the invention. It is to be understood that the description is for illustrative purposes only, and is non-limiting.

Web search engines have become major gateways for web information retrieval. Sponsored search is now a multi-billion dollar business. The sponsored search bidding process, ranking and auction pricing have been evolved continuously. Eventually, pricing schemes based on a single factor, bid amount, have previously evolved to be replaced by schemes based on two factors, bid amount and click-through-rate (CTR). The reason for this is clear, since revenue for a marketplace provider such as a search engine may be determined using bid amount multiplied by the number of clicks.

With the per click price for a keyword getting higher, advertisers are more careful in managing their campaigns. One way often used is to limit the budgets over a period of time, such as daily budgets, on accounts or campaigns, and shift the budget between campaigns or portions thereof, to better fit to the market changes. For many major search engines, the daily maximum spending, or the budget, can be specified at account, campaign or even at the keyword group levels. When the daily budgets for campaigns are tight, the utilization of the search results pages (SERP) and the total revenue for a search engine is very much tied with a budget-based factor. The following simplified example illustrates how budgets influence total revenue for a marketplace provider such as a search engine.

In the following simplified example, no particular pricing schema is used, and it is assumed that the search engine can earn a fixed price (cost per click, or CPC) from each click of an ad (ad), whether the CPC is user specified or an estimated average value. Suppose there are three bidders A, B and C for a given phrase. The bidding data is given in the following table.

TABLE 1

| Bidder | Cost per click ($) | Daily Budget($) |
|---|---|---|
| A | 1.00 | 100.00 |
| B | 0.50 | 50.00 |
| C | 0.40 | 500.00 |

The ads from the three bidders are assigned to a results page. Suppose from the history data, the average total numbers of daily clicks are obtained at various positions as in the table below.

TABLE 2

| Position | Average daily clicks |
|---|---|
| 1 | 200 |
| 2 | 140 |
| 3 | 60 |

These hypothetical numbers of clicks are the results for an average advertiser. For purposes of this example, it is simply assumed that same click-through-rate applies for all three bidders, i.e. they are all “average”. In that case, the default ranking is the bid amount for the circumstances, i.e. the ranking is fixed as 1, 2, 3 for A, B and C. A naive way to serve the ads is to show ads in this order until either the budget is exhausted or day ends. Following this service plan, the delivery for a typical day can be shown in the following table.

TABLE 3

Time Share

| | 0.5 | 0.15 | 0.35 |
|---|---|---|---|
| | (12 hours) | (3.6 hours) | (8.4 hours) |
| Position | clicks | clicks | clicks |
| 1 | A 100 | B 30 | C 70 |
| 2 | B 70 | C 21 | |
| 3 | C 30 | | |

Both A and B reached their maximum budget for the day and C gets 121 clicks for a revenue of $48.4. The total revenue from the page is $198.4.

However, if one does a little more planning, it is easy to see that A and B have tight budget. Even if one keeps the ranking order A, B and C, one can serve A and B alternatively at position 1 and keep C at position 2 until both A and B maxed out, as shown below.

TABLE 4

Time Share

| | 0.5 | 0.5 |
|---|---|---|
| Position | clicks | Clicks |
| 1 | A 100 | B 100 |
| 2 | C 70 | C 70 |

With this plan, C gets 140 clicks or $56 and total revenue is $206.0.

Going still further by way of optimization, if one is given the freedom to serve ads in any order to earn the most revenue, then a more optimized way of serving is to put C at position 1 and alternatively serving A and B at position 2 and 3, as shown below.

TABLE 5

Time Share

| | 0.5 | 0.5 |
|---|---|---|
| Position | clicks | Clicks |
| 1 | C 100 | C 100 |
| 2 | A 70 | B 70 |
| 3 | B 30 | A 30 |

Then C gets 200 clicks or $80. The total revenue is $230.

From this highly simplified example, one can nonetheless see that ignoring the daily budget may potentially cause a high revenue loss. Even under typical current ranking and pricing schema, a planned service schedule may help a search engine save some money. If one allows the correct or optimized ranking based on a third factor, specifically, a budget, such as a daily budget, the inventory of the search engine results pages can be better utilized and the revenue saving can be very significant. Not only that, but it can be viewed that more optimized ranking brings a healthier marketplace overall.

The following provides a more detailed review of typical contexts and non-limiting explanations of some embodiments of the invention.

Typically, when a user types in a search query, the search engine returns a search engine results page (SERP). In the results page, there are two main lists. One is organic or algorithmic list. The other is the sponsored or paid search list. The sponsored list can be empty for many queries.

Typically, a part or portion of SERP spaces are sold for sponsored listings or ads using auction method. Advertisers enter bids for search queries and set up the text contents for the link. A bid typically consists of the following information. First of all, the bid phrase and the match type, which tells the search engine the targeted search queries. When the match type is not “exact”, the search engine may match the bid with search phrases that are considered relevant but not exactly same as the bid phrase. The bid may need to specify the maximum cost the advertiser is willing to pay for each click, or the max CPC. The bid may also need to specify the creative, or the ad that shows on the SERP.

Bid phrases can be organized in a various levels of grouping. These include ad group, campaign, and account, among potentially many others. Ad groups may be user defined or related groups of ads within a campaign, and the campaign may be one of several associated with an account of a particular advertiser. The bid may specify the maximum spending or budgets, such as daily budgets, at various grouping level. For example, when the total cost reaches the budget, the ads within the specified level may not shown for the rest of the period or day, to avoid additional spending.

When bids are entered, the search engine ranks the bids to determine who wins which position and starts to facilitate serving or to serve or to map search queries to sponsored lists. When a sponsored link is clicked, the bidder pays the search engine a certain amount that is determined by the auction rules.

Although bids can be entered or changed any time of the day, the search engine needs time to organize bids and push the new data into the search server. The length of the latency period depends on the search engine and may be a few hours. It can be regarded, assumed or estimated, such as for explanation purposes, or even actually implemented that for a short service period, one or a few hours, the bids are kept same.

Most of search engines allow various types of user targeting. For example, this may include showing ads only to users in certain locations, which may be included within or known as geographic targeting or geotargeting, or showing ads only at certain time of the day, which may be included within or known as day parting. Such targeting conditions are also entered or included as part of the bids and often cost structures may vary for these additional conditions.

In some embodiments of the invention, marketplace provider revenue is estimated or predicted and maximized for a given future period. Furthermore, in some embodiments, a linear programming technique or an algorithm utilizing linear programming, is used for this and for associated planning. In some embodiments, other types of techniques and algorithms may be used, which may include data mining, machine learning and optimization techniques.

In some embodiments, a linear programming formulation is used to find an optimal service plan for the next service period. Herein, the term optimize broadly includes techniques or methods that are better relative to others or best or near best among all feasible solutions. Other forms of the word “optimize” have similar broad meanings herein.

In some embodiments, the estimate uses cost per click (CPC) values to find out the maximum revenue a search engine can earn under the current bid conditions. The CPC value can be the bid amount (max CPC), and the objective may be a theoretic maximum revenue. One can also use an average CPC, in which case the results may be closer to the service practice. In one embodiment, the CPC from generalized second price auction is used and the optimization results are used for ranking purpose only. One may also estimate a number of clicks for each position on each result page.

In some embodiments, the bidders are allowed to specify daily maximum spending at some grouping levels. For example, to represent this relationship in a network, let a node represent an account, a campaign, a group and a bid. Graphically the structure is a simple tree. The formulation in this part of the network may be straight forward, but tedious. In the following formulation, for simplicity, an illustration is provided with one organization level, specifically the campaign level. This simplification allows focus on the revenue optimization problem.

Let C be the set of ad campaigns, the source nodes. Let B be the set of all bids, the ad campaign-keyword pairs. Every bid bεBbεB belongs to a single ad campaign cεC. cεC. Let B(c) be the set of bids that belong to ad campaign c. For every ad campaign c, they system is given a maximum spending amount for the next serving period, denoted by Budget(c). Similarly, the system may have click requirement Clicks(c), and the conversion requirement Convs(c). Depending on the application, any of the requirements may be optional. Also, the system may have a mixed situation, for example, some ad campaigns have conversion requirements, and some do not.

The system may assign a bid to some positions in a search engine results page (SERP). Let S be the set of all SERPs and P be the set of all positions. For any position p, let s=serp(p) be the SERP that contains p. In the network representation, a bid is linked to all eligible positions. The relationship is denoted by (b, p)εA. For each position p, the system estimates how many clicks on the position for the next service period. This is an advertiser neutral average, and is denoted by clicks(p). The system also estimates an advertiser neutral cost per click for each position, cpc(p).

Because of many factors, advertisers have different click-through-rates for each keyword. The system captures the difference in a quality score q(b), or so called “clickablity” (CLKB). The expected number of the clicks that a bid b can get from position p is q(b)*clicks(p). For a search engine, the average cost of placing a bid b on position p for the next serving period is cpc(p)clicks(p). For ad campaigns with conversion requirement, the system also needs to have the conversion rate a(b, p).

For each SERP s, the system has estimated relevance score r(b). The system would preferably have the ad placement on the page reach a desired level R(s).

In the following linear programming formulation, the system has capacity and budget constraints. The system has the assignment constraints to link the supply and demand sides. The objective is to maximize the total revenue. There are two sets of the decision variables. Let x_{c,b} be the dollar amount assigned to bid b from ad campaign c. Let y_{b,p} be the shares of serving period when bid b is assigned to position p. The system has 0≦y_{b,p}≦1. In some applications, the system preferably solves an integer programming problem by requiring y_{b,p} in {0, 1}.

In the LP1 equations below, the objective is to minimize the total cost.

$$Min ( {\sum }_{c ∈ C} {\sum }_{b ∈ B ( c )} {x}_{c , b} ) . \qquad ( Equation LP1 \text{-} 1 )$$

An optional constraint that requires the cost for an ad campaign is limited by a budget. Without this constraint, the system minimizes the budget for all ad campaigns while allowing some ad campaigns having negative revenue,

$${\sum }_{b ∈ B ( c )} {x}_{c , b} \leq Budget ( c ) , ∀ c ∈ C . \qquad ( Equation LP1 \text{-} 2 )$$

The cost of a bid is the total from all its positions,

$${x}_{c , b} - {\sum }_{\{ p : ( b , p ) ∈ A \}} cpc ( p ) clicks ( p ) {y}_{b , p} = 0 , ∀ b ∈ B . \qquad ( Equation LP1 \text{-} 3 )$$

The total number of clicks is no less than the ad campaign requirement,

$${\sum }_{b ∈ B ( c )} {\sum }_{\{ p : ( b , p ) ∈ A \}} q ( b ) clicks ( p ) {y}_{b , p} \geq Clicks ( c ) , \\ ∀ c ∈ C . \qquad ( Equation LP1 \text{-} 4 )$$

For ad campaigns that has conversion requirements are satisfied,

$${\sum }_{b ∈ B ( c )} {\sum }_{\{ p : ( b , p ) ∈ A \}} a ( b , p ) q ( b ) clicks ( p ) {y}_{b , p} \geq Convs ( c ) , \\ ∀ c ∈ C . \qquad ( Equation LP1 \text{-} 5 )$$

The average relevance of ad placements in a SERP is at a preferable level. This constraint may be soft, for example, violate the constraint only costing some penalties.

$${\sum }_{\{ p : s = serp ( p ) \}} ( {\sum }_{\{ b : ( b , p ) ∈ A \}} ( r ( b ) - R ( s ) ) {y}_{b , p} ) \geq 0 , \\ ∀ s ∈ S . \qquad ( Equation LP1 \text{-} 6 )$$

A less demanding constraint is asking for average relevance on ad campaign reach certain level,

$${\sum }_{b ∈ B ( c )} ( r ( b ) - R ( c ) ) {y}_{b , p} ) \geq 0 , ∀ c ∈ C . \qquad ( Equation LP1 \text{-} {6}^{′} )$$

The shares of clicks at each position sum up to at most one,

$${\sum }_{\{ b : ( b , p ) ∈ A \}} {y}_{b , p} \leq 1 , ∀ p ∈ P . \qquad ( Equation LP1 \text{-} 7 )$$

The shares of clicks at each bid sum up to at most one,

$${\sum }_{\{ p : ( b , p ) ∈ A \}} {y}_{b , p} \leq 1 , ∀ b ∈ B . \qquad ( Equation LP1 \text{-} 8 )$$

Nonnegative for both x and y,

x_{c,b}≧0,y_{b,p}≧0 (Equation LP1-9)

The formulation may be easily modified to fit different business requirements. Some of the constraints may not be needed or may be softened by using an auxiliary variable and penalize for violations. The objective functions may also be changed.

A few applications are described below that use the formulation.

### Generalized Second Price (GSP) Auction

In the following, the generalized second price auction is described, and embodiments of the invention are illustrated in association therewith.

In a second-price sealed-bid auction, the winning bidder pays the highest bid amount of non-winners. The idea has been applied to sponsored search. The eligible bidders for one search are b₁, b₂, . . . , bₖ and their bids are bid(bᵢ), i=1, . . . , k. The initial application of some search engines was to rank the bidders by the descending order of the bid amount. If the ith bidder's ad is clicked then she pays the bid price of the (i+1)th bidder. In this mechanism, the ranking and pricing based on one factor, the bid price. Herein, this implementation is called a 1-factor second price auction.

However the seller's revenue may be the product of the price and the number of clicks. In other words, for each result page delivery, the other half of the revenue is the probability of an ad being clicked. This probability, called the click-through-rate (CTR), depends on the advertiser and the text, or creative, of the ad. Another generalization of the second price auction came to be utilized, herein called a 2-factor second price auction. In some implementations, the ranking depends on the product of two factors, the bid and the click-through-rate, equivalent to the expected bid value v(b, p)=bid(b)q(b, p). If the ith position in a page is denoted pᵢ and the ith ranked bidder is bᵢ. One has v(bᵢ, pᵢ)>v(bⱼ, pⱼ), ∀i<j. The price for bidder on the ith ranking is determined by the following:

cpc(bᵢ)=bid(bᵢ₊₁)q(bᵢ₊₁,pᵢ₊₁)/q(bᵢ,pᵢ₊₁) (Equation 2-1)

and the lowest ranked bidder pays the reserve price.

Note some search engines assign reserve prices for every bidder-page pairs and if the bid amount is less than the reserve price then the bid is regarded as ineligible for the page. Herein only eligible bids are discussed, although embodiments of the invention are not so limited. As discussed previously, the ranking determined by the 2-factor second price coincides with the optimization ranking under the condition that every campaign is budget sufficient.

A difficulty in incorporating the third major factor, the budget, into the second price auction is that the measure of budget tightness cannot be made locally on one page. One has to consider all campaigns and all accounts to know if the budget for one campaign is actually tight. One way to localize the problem is to use past service experience to determine a throttling rate for each campaign. For example, if a campaign has a throttling rate of 0.7 then it only needs to be served 30% of times. However, this is not ideal because it may leave many empty positions during the serve. As such, a localized adjustment in a two-factor marketplace is not ideal. A better or true optimal solution must include better ordering and utilization of an SERPs.

From the foregoing, it is shown that, when budgets are not considered, an optimization solution returns the same ranking as in the generalized second price auction.

In some embodiments of the invention, an optimization is used that further considers the budget limitations and returns a solution that best utilizes the spaces in the result page. In Example 1, it has been shown that the rank change is inevitable when one wants to better utilize the SERP spaces. Some embodiments of the invention use the prices determined by the 2-factor second price auction in Equation 2-1. Following this, an optimization algorithm or inventory optimization algorithm may be used to determine the final ranking under the given prices. Some embodiments of the invention include the following steps:

Step 1, Rank and price all bids as in 2-factor second price auction.

Step 2, Run optimization with the prices calculated by (Equation 2-1).

Step 3, Use the optimization solution to guide the service.

In the following example, according to one embodiment of the invention, prices are used from the GSP auction. Let bid and the daily budget are same as in example 1. Click score and cost per click are added from the auction rule. The bidding data and the auction determined CPC data is given in the following table. The SERP data is still used as from previous example data, in that in average the number of clicks from position 1, 2 and 3 are 200, 140 and 60 respectively. It is assumed that the reserved price for the page is $0.40, i.e. the minimum payment for each click is 40 cents.

TABLE 6

| | | Click | Revenue | | |
|---|---|---|---|---|---|
| | | Score | rate | | Daily |
| Bidder | Bid ($) | q(b, p) | v(b, p) | CPC($) | Budget($) |
| A | 1.00 | 1.0 | 1.0 | 0.66 | 100.00 |
| B | 0.50 | 1.3 | 0.65 | 0.47 | 50.00 |
| C | 0.40 | 1.5 | 0.6 | 0.40 | 500.00 |

A direct service using the 2-factor second price auction serves in order (A,B,C) until budget exhaust. The advertiser A′s budget exhausts when receives 100/0.66=151.52 clicks, budget for B exhausts when B receives 50/0.47=106.38 clicks. Note that B has click score of 1.3, so it can get 140*1.3 clicks if assigned to position 2. Similarly for C, it gets 1.5 times clicks per time unit. Since the solution always reaches maximum budget for A and B, it is only needed to count number of clicks on C and the revenues from it. The SERP service table is the following.

TABLE 7

Time Share

| | 0.5845 | 0.1731 | 0.2424 |
|---|---|---|---|
| Position | Clicks | Clicks | Clicks |
| 1 | A 116.90 | A 34.62 | C 72.72 |
| 2 | B 106.38 | C 36.35 | |
| 3 | C 52.61 | | |

The total clicks for C 161.68 and total revenue for C is $64.67. The total revenue for all three is $214.67. An obvious problem is that the page is not well utilized. The position 2 and 3 are not fully served.

A more optimal solution uses the same price for each bidder. It fully serves all three positions during the service period and therefore better utilizes the page.

TABLE 8

Time spend

| | 0.5558 | 0.2729 | 0.1713 |
|---|---|---|---|
| Position | Clicks | Clicks | Clicks |
| 1 | A 111.16 | C 81.87 | C 51.39 |
| 2 | C 116.72 | B 49.67 | A 23.98 |
| 3 | B 43.35 | A 16.37 | B 13.36 |

Total clicks for C=249.98 and total revenue from C is 99.99. The total revenue for all three is $249.99.

In the following example, effects of one bidder's change on budget or bid amount are considered. If B added 20% or $10 to its budget, then all the money added works on gaining more clicks for B. An optimal solution is shown in Table 9.

TABLE 9

Time Share

| | 0.5225 | 0.3463 | 0.1312 |
|---|---|---|---|
| Position | Clicks | Clicks | Clicks |
| 1 | A 104.5 | C 103.90 | A 26.24 |
| 2 | C 109.73 | B 63.03 | B 23.87 |
| 3 | B 40.76 | A 20.78 | C 11.81 |

Total clicks for C=225.44 and revenue=90.176. The revenue increase from B almost equals the decrease from C. The new schedule returns total revenue $250.17.

However, if instead of increasing the budget, B increases 20% of his bid to $0.60. In this case, CPC for A is increased to $0.78. An optimal solution is shown in Table 10.

TABLE 10

Time share

| | 0.1673 | 0.5598 | 0.2729 |
|---|---|---|---|
| Position | clicks | clicks | clicks |
| 1 | A 33.46 | C 167.94 | C 81.87 |
| 2 | C 35.13 | A 78.37 | B 49.67 |
| 3 | B 13.05 | B 43.66 | A 16.37 |

The change reduces the clicks for A from 151.52 to 128.2 as general second price auction usually does. However it also increases clicks for C from 249.98 to 284.94. With the budget factor optimization, the budget sufficient accounts get the benefit when other accounts further tightening the budget.

The example shows when budget is tight, adding budget can gain more clicks right away. Bidding over value with a tight budget may help others.

With search volume increases, staying at top positions all the time can be very expensive for advertisers. At the same time, the SERP spaces are valuable resources for search engines. Even from very small examples, one can see significant waste by keeping a predetermined ranking. In some embodiments, a better solution is provided using inventory optimization and using determined ranks. In some embodiments, the bidders will obtain the same or more clicks with same prices as serviced by the existing 2-factor generalized second price auction, however their ranking may vary during the serving period. When optimization is used, the search engine can better utilize the SERP to achieve maximize the revenue.

The foregoing example also shows the effects with bid changes. An inventory optimization algorithm of a search engine can have a further advantage of keeping bidders bidding on their own values.

### Ad Campaign Recommendations

While the keyword selection and bid amount are the decisions of advertisers, search engines often make recommendations to guide them. The formulations may be used as a base of such recommendations, in particular when many advertisers request for recommendations. In contract to a single ad campaign based optimization method, the above formulation provides a global solution based on available inventory and various ad campaign requests that may include desired level of budgets, click quantities and click qualities.

### Optimizing Sponsored Search Ad Placement

Some prior systems, discussed above, are configured to use a linear programming formulation that may alter the ranking for advertisers with tight budgets. The present system is configured for using an expanded formulation and for proposing a phrase (e.g., keyword) elimination method that results in ad ranking that coincides with ad ranking of the generalized second price auction, which is discussed above.

The linear programming solution, discussed above, may be used to indicate which ad campaigns or accounts are budget tight (e.g., have a budget constraint). For a budget tight ad campaign, the system may then eliminate some bids (e.g., keywords) from the ad campaign. After the bid eliminations, the overall network and prices are changed. The system re-solves the optimization formulation for the new network. Repeating the iterations, the system derives a network where every ad campaign is budget sufficient.

The present formulation may be applied to optimize sponsored search ad placement for multiple advertisers (e.g., not necessarily all advertiser accounts in the search engine). When the present formulation is applied for multiple advertisers for optimizing the search engine revenue, then the present system preferably does not alter the ranking (described above). Rather, the present system preferably eliminates some keywords for the budget tight accounts without altering the ranking.

The elimination of keywords enhances and coincides with ad ranking of the generalized second price auction, which is discussed above. To optimize sponsored search ad placement by eliminating keywords, the ad placement optimization system may be further configured to include the following steps:

Step 1, calculate initial prices of ad slots by using methodology of 2-factor generalized second price auction.

Step 2, solve linear programming (e.g., LP1 Equations) by using the calculated initial prices.

Step 3, if all ad campaigns are budget sufficient or if the solution has a generalized second price auction order, then bypass Step 4.

Step 4, if not all ad campaigns are budget sufficient or if the solution does not have a generalized second price auction order, then eliminate one or more bid-position links for budget tight ad campaigns and return to Step 2. In this step 4, the system needs to determine which bids (e.g., key words) to eliminate for budget tight advertisers. For example, when an advertiser has a budget constraint, the budget constraint may be accommodated by the system eliminating bids (e.g., keywords).

A number of different heuristics may be used for the elimination of bids (e.g., keywords). One example of such a heuristic is a method referred to as advanced matched keywords (e.g., broad matched keywords). When an advertiser bids on a keyword, the advertiser may specify to allow advanced match (e.g., broad match). In such a case, the search engine may find search phrases that are relevant to the bid phrase and place the ad there. Usually, the search engine has a measure of relevance. The system may use this relevance measure to eliminate less relevant advanced matches until the budget is sufficient for the remaining keywords. Advanced matches usually represent a significant percentage of revenue. Therefore, this method may resolve a large number of budget tight problems.

For budget tight ad campaigns that do not have advanced matches, the system chooses pages where the ECPM value q(b)*bid(b) is closest to its previous bidders and next bidders. One example of a detailed calculation is described below. Under the generalized second price auction, the revenue impact of removing one ad from a page may be calculated as follows. During the serving period, the total revenue from a page is the following:

$${\sum }_{i = 1}^{P} cpc ( {b}_{i} ) q ( {b}_{i} ) clicks ( i ) . \qquad ( Equation 3 \text{-} 1 )$$

Here, bᵢ is the bid that gets the ith position in the page.

It is given that the number of clicks clicks(i) reduces significantly as position i increases. If a bid bⱼ is removed from the list, the revenue changes from the position j−1 downwards may be calculated as follows:

$${\sum }_{i = j - 1}^{j + h} [ bid ( {b}_{i + 1} ) q ( {b}_{i + 1} ) - bid ( {b}_{i} ) q ( {b}_{i} ) ] clicks ( i ) . \qquad ( Equation 3 \text{-} 2 )$$

Using this formulation, the system may find the pages where revenue impact is at a minimum when eliminating a budget tight bid. This provides a way to iteratively eliminate least impacted pages for a budget tight ad campaign. In order to keep optimality, the iterations should be taken in a small step size. One or only a few pages are eliminated and the linear programming is resolved to determine further elimination.

At the end of iterations, every ad campaign is budget sufficient. Accordingly, the generalized second price auction ordering is reserved. In most cases, an ad campaign bids on hundreds to thousands of keywords. The elimination of one keyword should have a minor impact on the total ad campaign budget. In case an ad campaign has fewer keywords, a fractional elimination using part of serving time may also be considered.

### Overview of Method for Optimizing Sponsored Search Ad Placement

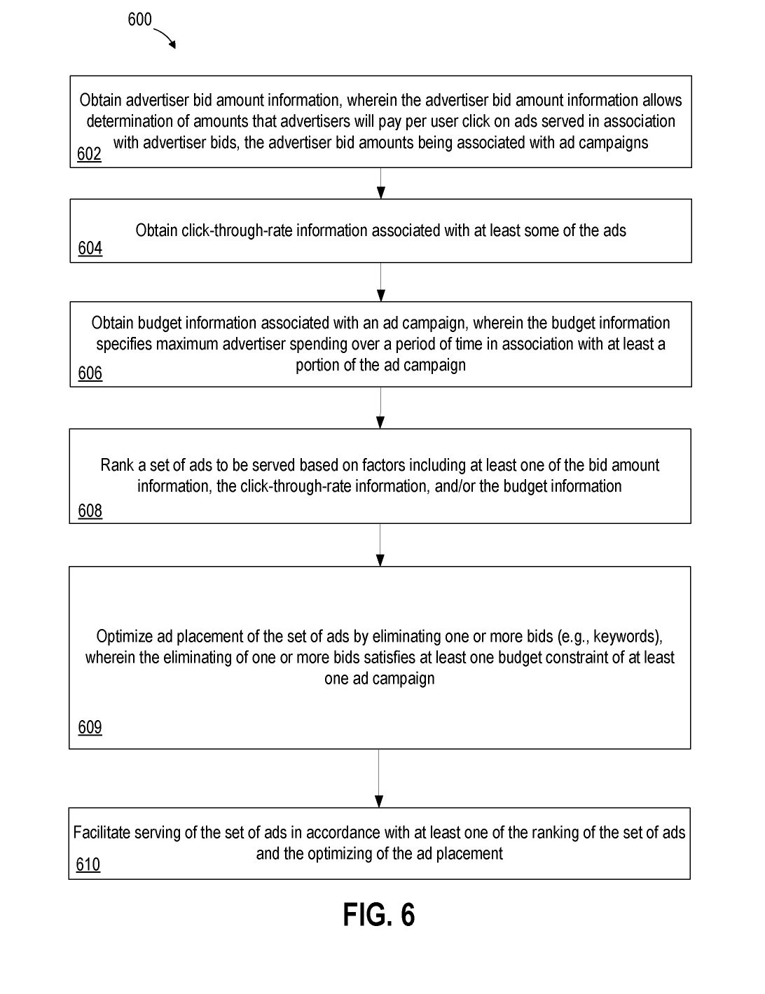

FIG. 6 is a flowchart of a method 600 for optimizing sponsored search ad placement (e.g., item placement) for online advertising (e.g., online messaging), in accordance with some embodiments. The steps of the method 600 may be carried out by one or more devices of the system 100 of FIG. 1. The steps of the method 600 may also be carried out by one or more devices of the system 400 of FIG. 4.

The method 600 starts in a step 602 where the system obtains advertiser (e.g., messenger) bid amount information. The advertiser bid amount information allows determination of amounts that advertisers will pay per user click on ads (e.g., items) served in association with advertiser bids (e.g., messenger bids). The advertiser bid amounts (e.g., messenger bid amounts) are associated with ad campaigns (e.g., item campaigns).

The method 600 moves to a step 604 where the system obtains click-through-rate information. The click-through-rate information is associated with at least some of the ads.

The method 600 proceeds to a step 606 where the system obtains budget information associated with an ad campaign. The budget information specifies a maximum advertiser spending over a period of time in association with at least a portion of the ad campaign.

The method 600 moves to a step 608 where the system ranks a set of ads to be served based on at least one of the following: the bid amount information, the click-through-rate information and/or the budget information. The budget information specifies budgets that include spending associated with user clicks on ads associated with the bid amounts. The system preferably uses a revenue maximization method implemented as linear programming for the ranking process.

The method 600 proceeds to a step 609 where the system optimizes ad placement of the set of ads by eliminating one or more bids (e.g., keywords). The eliminating of one or more bids satisfies at least one budget constraint of at least one ad campaign.

Next in a step 610, the system facilitates serving of the set of ads in accordance with the ad ranking and/or the ad placement optimization.

Note that the method 600 may include other details and steps that are not discussed in this method overview. Other details and steps are discussed with reference to the appropriate figures and may be a part of the method 600, depending on the embodiment.

### Exemplary Network, Client, Server and Computer Environments

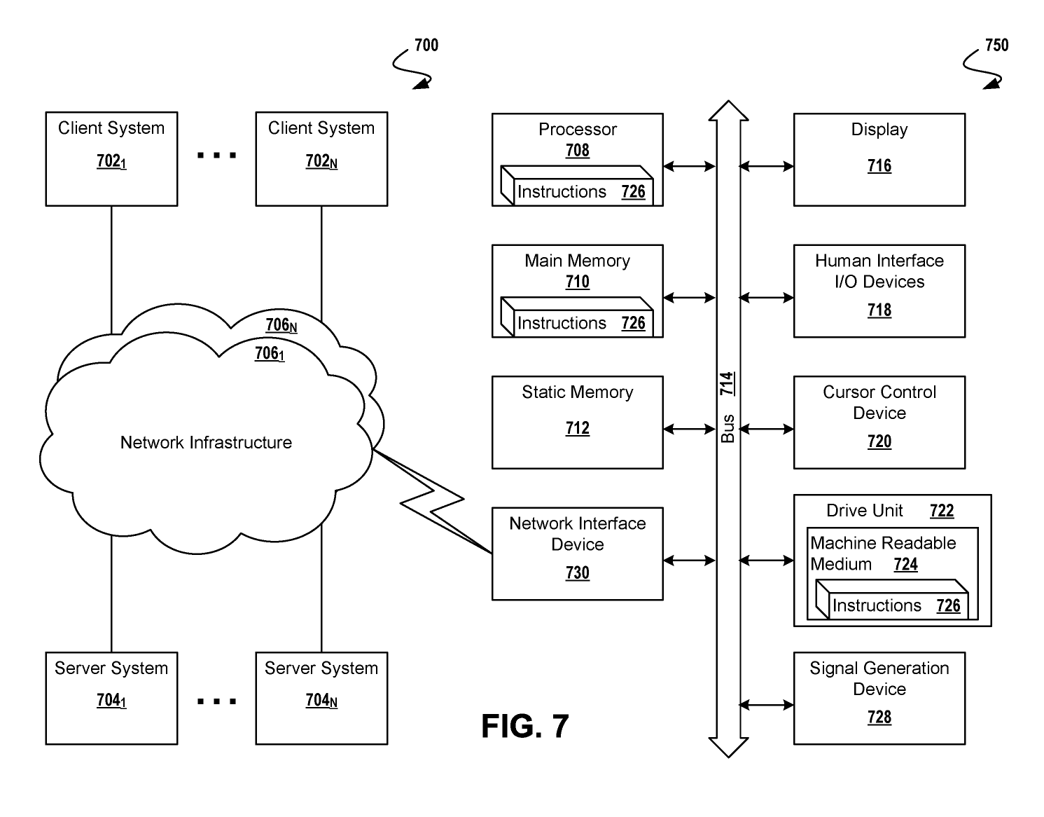

FIG. 7 is a diagrammatic representation of a network 700, including nodes for client systems 702₁ through 702_{N}, nodes for server systems 704₁ through 704_{N}, nodes for network infrastructure 706₁ through 706_{N}, any of which nodes may comprise a machine 750 within which a set of instructions, for causing the machine to perform any one of the techniques discussed above, may be executed. The embodiment shown is exemplary, and may be implemented in the context of one or more of the figures herein.

Any node of the network 700 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g., a client computer system, a server computer system) and/or may comprise one or more embedded computer systems, a massively parallel computer system, and/or a cloud computer system.

The computer system 750 includes a processor 708 (e.g., a processor core, a microprocessor, a computing device, etc.), a main memory 710 and a static memory 712, which communicate with each other via a bus 714. The machine 750 may further include a display unit 716 that may comprise a touch-screen, or a liquid crystal display (LCD), or a light emitting diode (LED) display, or a cathode ray tube (CRT). As shown, the computer system 750 also includes a human input/output (I/O) device 718 (e.g. a keyboard, an alphanumeric keypad, etc), a pointing device 720 (e.g., a mouse, a touch screen, etc), a drive unit 722 (e.g., a disk drive unit, a CD/DVD drive, a tangible computer readable removable media drive, an SSD storage device, etc.), a signal generation device 728 (e.g., a speaker, an audio output, etc.), and a network interface device 730 (e.g., an Ethernet interface, a wired network interface, a wireless network interface, a propagated signal interface, etc.).

The drive unit 722 includes a machine-readable medium 724 on which is stored a set of instructions 726 (e.g., software, firmware, middleware, etc.) embodying any one, or all, of the methodologies described above. The set of instructions 726 is also shown to reside, completely or at least partially, within the main memory 710 and/or within the processor 708. The set of instructions 726 may further be transmitted or received via the network interface device 730 over the network bus 714.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing or transmitting information in a form readable by a machine (e.g., a computer). For example, a machine-readable medium includes read-only memory (ROM); random access memory (RAM); magnetic disk storage media; optical storage media; flash memory devices; electrical, optical or acoustical or any other type of media suitable for storing information.

### ADVANTAGES

A system is provided for solving the ad placement problem for a set of ad campaigns. The formulation takes into consideration inventory limitations, ad campaign budget constraints, search relevance, and click conversion rates, among other things. The formulation may be applied to solve a wide range of problems, including without limitation budget limited inventory optimization, advertiser keywords and bid recommendations.

The system is configured to capture the essentials of the problems and to be flexible enough to fit into various applications. A problem is to determine positions for multiple ad campaigns and hundreds or thousands keywords from these ad campaigns. The objective of the system may be to maximize the overall revenue and keep a high relevance level for each search page. Alternatively, in case of the ad campaign recommendations, the objective may be to maximize the total clicks under a specified budget amount for each ad campaign.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A computer-implemented method optimizing sponsored search item placement, the method comprising:
obtaining, at a computer, messenger bid amount information, wherein the messenger bid amount information allows determination of amounts that messengers will pay per user click on items served in association with messenger bids, wherein the messenger bid amounts are associated with messaging campaigns;
obtaining, at a computer, click-through-rate information associated with at least some of the items;
obtaining, at a computer, budget information associated with the messaging campaign, wherein the budget information specifies a maximum messenger spending over a period of time in association with at least a portion of the messaging campaign;
ranking, at a computer, a set of items to be served based on at least one of the bid amount information, the click-through-rate information, and the budget information; and
optimizing, at a computer, item placement of the set of items by eliminating one or more keywords.

2. The method of claim 1, wherein the eliminating of one or more keywords satisfies at least one budget constraint of at least one messenger campaign.

3. The method of claim 1, wherein optimizing item placement includes at least one of:
calculating initial prices of item slots by using methodology of a generalized second price auction;
solving linear programming by using the initial prices to generate an item order;
determining if all messaging campaigns are budget sufficient;
determining if the item order has a generalized second price auction order; and
eliminating one or more bid-position links for budget tight messaging campaigns.

4. The method of claim 1, wherein the eliminating of one or more keywords includes at least one of:
advanced match keywords; and
broad matched keywords.

5. The method of claim 1, wherein the method further comprises at least one of:
facilitating, at a computer, operating of a sponsored search auction, wherein the sponsored search auction includes a second price auction;
facilitating, at a computer, serving of the set of items in accordance with the ranking of the set of items and the optimizing of the item placement; and
facilitating, at a computer, serving of the set of items in accordance with the optimizing of the item placement.

6. The method of claim 1, wherein determining ranking comprises using at least one of:
item inventory optimization; and
linear programming.

7. The method of claim 1, wherein obtaining the budget information comprises at least one of:
obtaining the budget information specifying a maximum messenger spending over a period of time in association with the messaging campaign;
obtaining the budget information specifying a maximum messenger spending over a period of time in association with an messenger account comprising the messaging campaign;
obtaining the budget information specifying a maximum messenger spend over a period of time in association with a specified set of items; and
obtaining the budget information specifying a maximum messenger spend over a period of time in association with one or more specified item groups.

8. The method of claim 1, wherein the budget is at least one of:
related to a repeating period of time; and
a daily budget.

9. The method of claim 1, wherein the click-through-rate information comprises at least one of:
predicted click-through-rate information;
historical click-through-rate information; and
estimated click-through-rate information.

10. The method of claim 1, wherein the budget information specifies budgets that include spending associated with user clicks on items associated with the bid amounts.

11. A system for optimizing sponsored search item placement, the system comprising:
a computer system configured for:
obtaining messenger bid amount information, wherein the messenger bid amount information allows determination of amounts that messengers will pay per user click on items served in association with messenger bids, wherein the messenger bid amounts are associated with messaging campaigns;
obtaining click-through-rate information associated with at least some of the items;
obtaining budget information associated with the messaging campaign, wherein the budget information specifies a maximum messenger spending over a period of time in association with at least a portion of the messaging campaign;
ranking a set of items to be served based on at least one of the bid amount information, the click-through-rate information, and the budget information; and
optimizing item placement of the set of items by eliminating one or more keywords.

12. The system of claim 11, wherein the eliminating of one or more keywords satisfies at least one budget constraint of at least one messenger campaign.

13. The system of claim 11, wherein optimizing item placement further configures the computer system for at least one of:
calculating initial prices of item slots by using systemology of a generalized second price auction;
solving linear programming by using the initial prices to generate an item order;
determining if all messaging campaigns are budget sufficient;
determining if the item order has a generalized second price auction order; and
eliminating one or more bid-position links for budget tight messaging campaigns.

14. The system of claim 11, wherein the eliminating of one or more keywords further configures the computer system for at least one of:
advanced match keywords; and
broad matched keywords.

15. The system of claim 11, wherein the computer system is further configured for at least one of:
facilitating, at a computer, operating of a sponsored search auction, wherein the sponsored search auction includes a second price auction;
facilitating, at a computer, serving of the set of items in accordance with the ranking of the set of items and the optimizing of the item placement; and
facilitating, at a computer, serving of the set of items in accordance with the optimizing of the item placement.

16. The system of claim 11, wherein determining ranking comprises using at least one of:
item inventory optimization; and
linear programming.

17. The system of claim 11, wherein obtaining the budget information comprises at least one of:
obtaining the budget information specifying a maximum messenger spending over a period of time in association with the messaging campaign;
obtaining the budget information specifying a maximum messenger spending over a period of time in association with an messenger account comprising the messaging campaign;
obtaining the budget information specifying a maximum messenger spend over a period of time in association with a specified set of items; and
obtaining the budget information specifying a maximum messenger spend over a period of time in association with one or more specified item groups.

18. The system of claim 11, wherein the budget is at least one of:
related to a repeating period of time; and
a daily budget.

19. The system of claim 11, wherein the click-through-rate information comprises at least one of:
predicted click-through-rate information;
historical click-through-rate information; and
estimated click-through-rate information.

20. The system of claim 11, wherein the budget information specifies budgets that include spending associated with user clicks on items associated with the bid amounts.

21. A computer readable medium comprising one or more instructions for optimizing item placement, wherein the one or more instructions are configured for causing one or more processors to perform the steps of:
obtaining, at a computer, messenger bid amount information allowing determination of amounts that messengers will pay per user click on items served in association with messenger bids, wherein the messenger bid amounts are associated with messaging campaigns;
obtaining, at a computer, click-through-rate information associated with at least some of the items;
obtaining, at a computer, budget information associated with the messaging campaign, the budget information specifying a maximum messenger spending over a period of time in association with at least a portion of the messaging campaign;
ranking, at a computer, a set of items to be served based on at least one of the bid amount information, the click-through-rate information, and the budget information;
optimizing, at a computer, item placement of the set of items by eliminating one or more keywords; and
facilitating, at a computer, serving of the set of items in accordance with at least one of the ranking of the set of items and the optimizing of the item placement.
